(19) United States
(12) Patent Application Publication
(10) Pub. No.: US 2004/0177983 A1
(43) Pub. Date: Sep. 16, 2004

(54) Box for decoder for irrigation systems

(76) Inventor: Roman Gianfranco, Pasiano (IT)

Correspondence Address: JACOBSON HOLMAN PLLC, 400 SEVENTH STREET N.W., SUITE 600, WASHINGTON, DC, 20004, US

(21) Appl. No.: 10/795,378

(22) Filed: Mar. 9, 2004

(30) Foreign Application Priority Data
Mar. 13, 2003 (IT) MI 2003U 000115

(51) Int. Cl. H02G 3/08

(52) U.S. Cl. 174/50

(57) ABSTRACT

Box for decoder provided with a plurality of passing through holes. In particular said box is made up of an elongated body having said passing through holes at both ends.

### DESCRIPTION

The present invention concerns a box for decoder for irrigation systems.

For the maintenance of lawns, gardens and other green spaces automatic irrigation systems are known that are controlled by central electronic control units normally called electronic central units.

Such types of systems can be of the type in which the central control unit is connected through a single pair of cables with all the solenoid valves belonging to the irrigation system; more precisely said control unit is connected by means of a single pair of cables to units each one comprising an solenoid valve and a decoder, that is a device suitable to decode and to codify electric signals which are received by and sent to the control unit.

The decoders can be of the type with two poles or three poles with an alternate or direct current supply.

In turn the single decoder can control a solenoid of each solenoid valve both in alternate as well as in direct current.

Said decoders are usually contained in boxes with cylindrical shape that get inserted into underground pits without any fastening, or they are fastened to a wall or to a wall of a cabinet by means of an opportunely shaped band and provided with two holes through which to pass the screws.

The known fastening system does not have an acceptable safety standard. The poor hold of the band can cause the fall of the decoder with evident economic damages. In addition the limited number of holes of the band does not allow a satisfactory freedom in the positioning of the decoder.

In view of the state of the art, object of the present invention is to provide a box for decoder that allows a more secure fastening and a greater positioning flexibility.

According to the present invention such object is attained by means of a box for decoder characterised in that it is provided with a plurality of passing through holes.

In particular said box is made up of an elongated body having the passing through holes at both ends.

The characteristics and the advantages of the present invention will become evident from the following detailed description of an embodiment thereof, illustrated as a non limiting example in the enclosed drawings, in which:

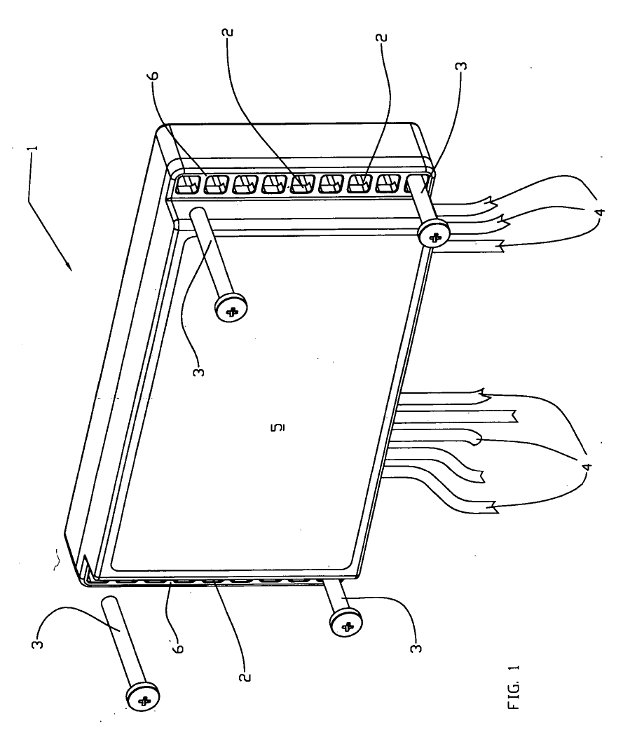

FIG. 1 shows the invention in axonometry;

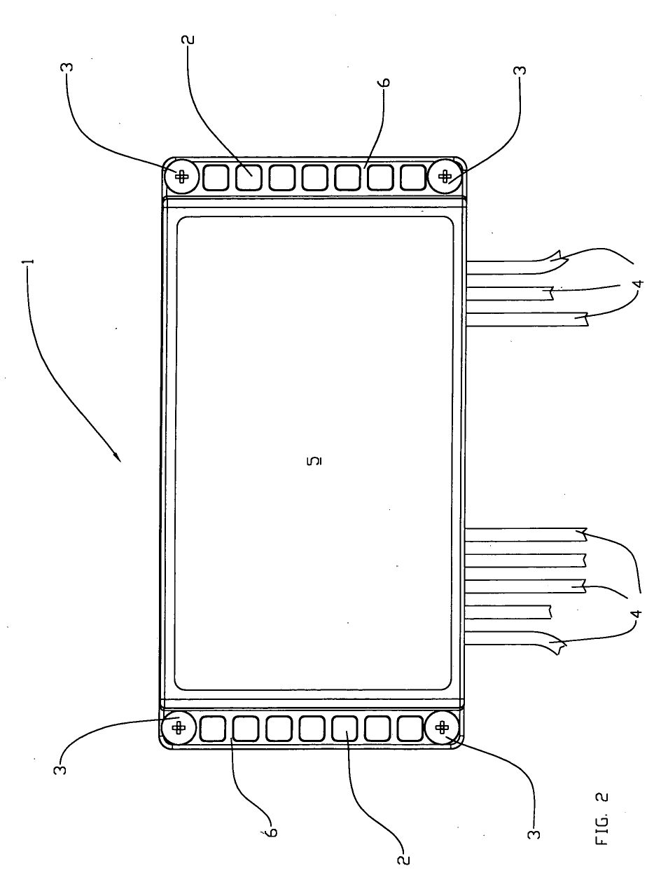

FIG. 2 shows the same invention in front view;

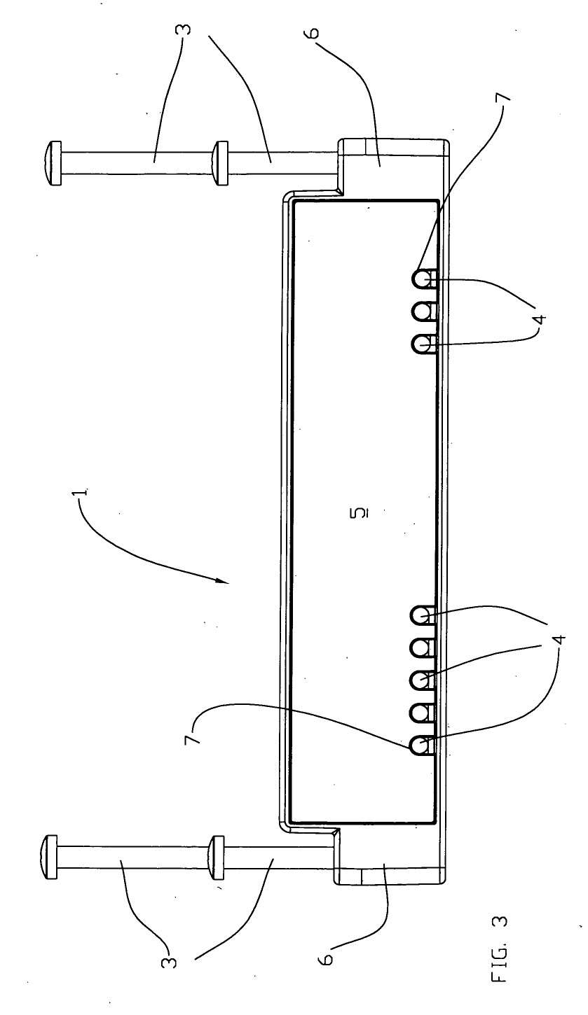

FIG. 3 shows the same invention in side view.

In the drawings a box 1 made up of a body 5 with elongated shape, substantially parallelepiped, is shown that contains on its inside the decoder and that has, in correspondence of the two short sides, lowered portions 6 provided with respective series of passing through holes 2 with square section.

In the aforesaid holes 1 screws 3 for the fastening of the box to a wall of cabinet or other are selective insertable.

A long side of the box 1 has holes 7 from which electric wires 4 for the connection of the decoder to a central control unit, to a solenoid valve and possible sensors extends.

1. Box for decoder characterised in that it is provided with a plurality of passing through holes.

2. Box according to claim 1, characterised in that said box is made up of an elongated body having said passing through holes at both ends.

3. Box according to claim 2, characterised in that said elongated body has side holes for the outlet of electric wires.
